(19) United States
(12) Patent Application Publication
(10) Pub. No.: US 2008/0043937 A1
(43) Pub. Date: Feb. 21, 2008

(54) System and method capable of automatically storing and retransmitting for an IP phone

(76) Inventor: Jian-Jun Qian, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/648,591

(22) Filed: Jan. 3, 2007

(30) Foreign Application Priority Data
Jun. 30, 2006 (TW) 95123763

(51) Int. Cl. H04M 1/64

(52) U.S. Cl. 379/67.1

(57) ABSTRACT

The present invention is directed to a system and method capable of automatically storing and retransmitting messages for an IP (Internet Prorocol) phone. The system includes a message database for storing unsent or new messages, and a parameter-setting unit for storing at least one parameter. Additionally, a message control center retrieves and retransmits the unsent messages, or retrieves and displays the new messages according to the parameter.

### BACKGROUND OF THE INVENTION

1. Field of the Invention

The present invention relates to an IP phone, and more particularly to a system and method capable of automatically storing and retransmitting messages for an IP phone.

2. Description of the Prior Art

The continued proliferation and expansion of network and broadband service make voice and image transmission through the internet become more and more popular. VoIP (Voice over Internet Protocol) is a protocol to transmit voice or image through internet. The transmission is carried out in the form of digital data packets. In the past, bandwidth limitation causes. VoIP scarcely comparable to the conventional telephone system. Nevertheless, the situation is altering by the progress in modern communication technique.

The development of IP phone under VoIP technology is fast. The IP phone based on the SIP (Session Initiation Protocol) is especially outstanding. One of the drawbacks of SIP, however, is the lack of instant message handling. The SIP server does not support functions for storing or retransmitting messages. When the called side is off-line, a delivered message is not stored or retransmitted as in a mobile phone message service. Instead, it simply returns an error code for such a case without any friendly design for clients.

In view of above circumstance, there is a need for a system and method capable of automatically storing and retransmitting messages for an IP phone.

### SUMMARY OF THE INVENTION

It is an object of the present invention to provide a system and method capable of automatically storing and retransmitting messages for an IP phone.

In accordance with above object, the present invention provides a system capable of automatically storing and retransmitting messages for an IP phone. The system includes a message database for storing unsent or new messages, and a parameter-setting unit for storing at least one parameter. Additionally, a message control center retrieves and retransmits the unsent messages, or retrieves and displays the new messages according to the parameter.

### BRIEF DESCRIPTION OF THE DRAWINGS

For a more complete understanding of the present invention, and the advantages thereof, reference is now made to the following descriptions taking in conjunction with the accompanying drawings, wherein like numbers designate like objects, and in which:

FIG. 1 shows a system diagram of a local message center in accordance with an embodiment of the present invention;

FIG. 2 shows a block diagram of a message sending module in accordance with the present invention;

FIG. 3 shows an operation flow of the message sending module shown in FIG. 2;

FIG. 4 shows a block diagram of a message receiving module in accordance with the present invention;

FIG. 5 shows an operation flow of the message receiving module shown in FIG. 4.

### DETAILED DESCRIPTION OF THE INVENTION

Preferred embodiments in accordance with the present invention will be described below in detail with reference to the accompanying drawings. Various embodiments used to describe the principles of the present invention in this patent document are by way of illustration only and should not be construed in any way to limit the scope of the invention.

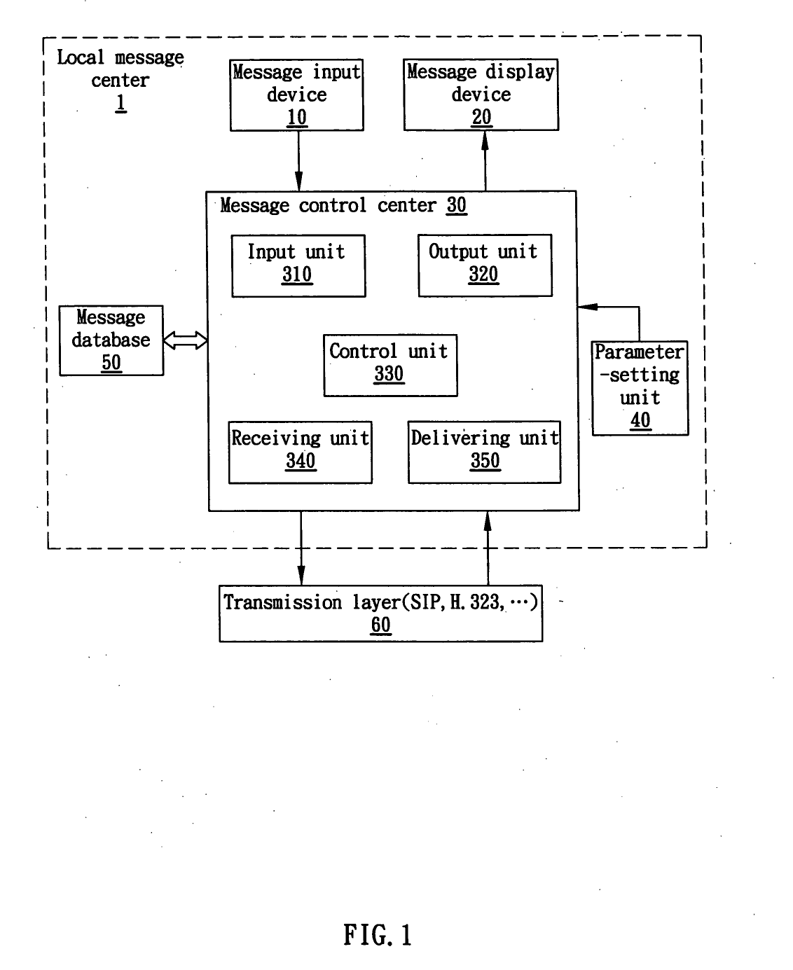

FIG. 1 shows a system diagram in accordance with an embodiment of the present invention, in which a local message center 1 is illustrated to demonstrate some terminal equipment, such as a personal computer or an IP phone, installed with application software at the client side. The local message center 1 includes a message input device 10, a message display device 20, a parameter-setting unit 40, a message database 50, and a message control center 30. The message control center 30 contains an input unit 310, an output unit 320, a control unit 330, a receiving unit 340, and a delivering unit 350.

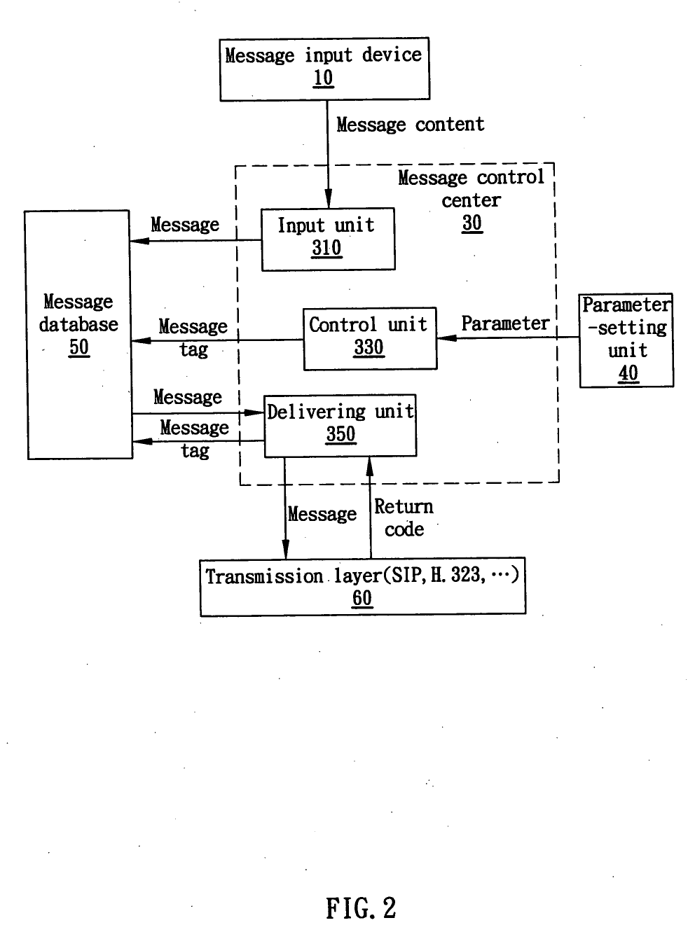

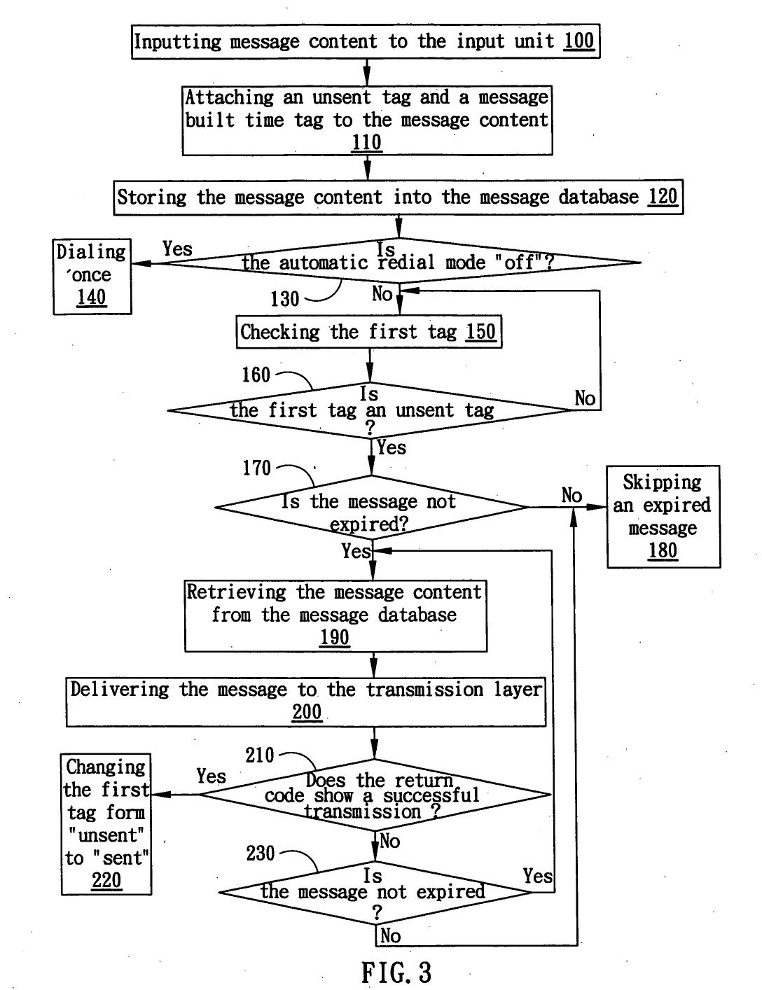

FIG. 2 shows a block diagram of a message sending module in accordance with the present invention. The message sending flow will be described with reference to the diagram of FIG. 2 and the flow chart shown in FIG. 3. A message is input via the message input device 10 which may be any peripheral input device such as a keyboard, a mouse, or a microphone. The original information represented by text, voice, or image of the message is processed by the message input device 10 and transformed to a message content. The message content is input to the input unit 310 in step 100. An unsent tag and a message built time tag are attached to the message content in step 110. In step 120, the message content is stored into the message database 50. The input unit 310 may be a software program for processing the message content from the message input device 10. All other units (320-350) in message control center 30 may also be software programs. The aforementioned “tags” are to mark status of the message content. There are three types of tags in the present embodiment: a first tag to mark a message as sent, unsent or expired, a second tag to mark a message new or not, and a message built time tag to register the time when the message is built in the input unit 310.

The control unit 330 processes message contents stored in the message database 50 according to parameters set by the parameter-setting unit 40. The control unit 330 may be a software process implemented as an independent thread control, so as to repeatedly execute a routine which is configurable through the parameters set by the parameter-setting unit 40. There are three parameters under control by the parameter-setting unit 40: automatic redial mode (on/off), polling interval, and expiration period. If the automatic redial mode is “off” in step 130, then the local message center 1 only dials once to the receiving end in step 140. If the automatic redial mode is “on” in step 130, then the control unit 330 will repeatedly check the first tag (step 150) to see whether it is an unsent message (step 160) in a frequency defined by the polling interval. For an unsent message, the control unit 330 will check if the message has been expired according to the expiration period as well as the message built time tag (step 170). If it is found to be expired, the control unit 330 will change the first tag to be expired and the local message center 1 will skip the expired message (step 180).

If it is not expired, the corresponding message content will be retrieved from the message database 50 to the delivering unit 350 (step 190). In step 200, the delivering unit 350 will packet the message content in accordance with the format of the communication protocol in transmission layer 60 and deliver the message packet to the transmission layer 60. The communication protocol in transmission layer 60 may be SIP (Session Initiation Protocol) or H.323 etc. The delivering unit 350 also checks a return code to determine if the delivering is successful in step 210. If the message is delivered successfully, the delivering unit 350 will change the first tag to be “sent” and store it back to the message database 50 in step 220. If the return code shows a transmission failure, then the message will be checked for the expiration period in step 230. If it is expired, the message will be skipped (step 180); otherwise, step 190 through step 230 will be repeated until the message is delivered successfully or expired.

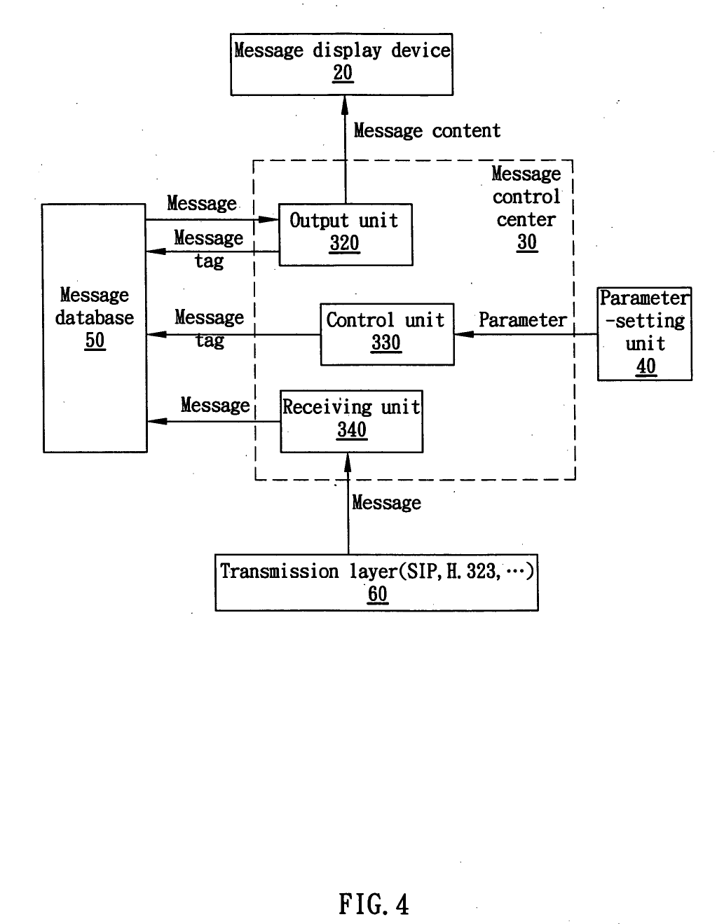

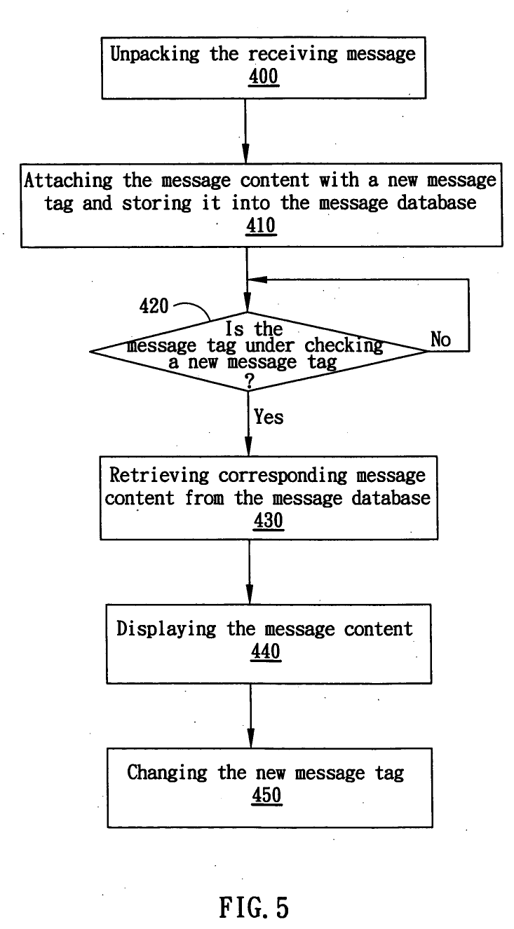

FIG. 4 and FIG. 5 respectively show a block diagram and an operation flow chart of a receiving module in accordance the present invention. The following description refers to both FIG. 4 and FIG. 5. The transmission layer 60 inputs a message to a receiving unit 340. The receiving unit 340 may also be implemented as an independent software thread to execute the task. The receiving unit 340 unpacks the receiving message packet in accordance with the communication protocol of the transmission layer 60 in step 400. The unpacked message content is attached with a new message tag and stored into the message database 50 in step 410. In step 420, the control unit 330 repeatedly checks the message database 50 for any new message in a frequency defined by the polling interval configured by the parameter-setting unit 40. If there is no new message tag found, the polling process to the message database 50 simply repeats; on the other hand, if a new message tag is found, the corresponding message content will be retrieved from the message database 50 in step 430. The output unit 320 will then deliver the message content to the message display device 20 for displaying in step 440. As soon as the message content is displayed, the output unit 320 also changes its second tag from “new tag” to “displayed tag” and stores it back to the message database 50.

It should be understood, however, that there is no intention to limit the invention to the specific embodiments disclosed, but on the contrary, the invention is to cover all modifications, alternate constructions and equivalents falling within the spirit and scope of the invention as expressed in the appended claims.

What is claimed is:

1. A system capable of automatically storing and retransmitting for an IP phone, the system comprising:
a message database for storing unsent messages or new messages;
a parameter-setting unit having at least one parameter setting; and
a message control center for retrieving the unsent messages from the message database for delivering, or retrieving the new messages from the message database for displaying in accordance with the at least one parameter setting.

2. The system as claimed in claim 1, wherein said at least one parameter setting comprises a polling interval, said message control center checking said message database repeatedly in a frequency defined in accordance with the polling interval for any said unsent message or said new message.

3. The system as claimed in claim 1, wherein said at least one parameter setting comprises an expiration period, said message control center skipping all said unsent messages residing in said message database for a time period longer than said expiration period.

4. The system as claimed in claim 1, wherein said at least one parameter setting comprises an automatic redial mode setting for enabling or disabling said message control center.

5. The system as claimed in claim 1, wherein said message control center comprises an input unit for inputting messages, attaching tags to the messages, and storing the messages into said message database.

6. The system as claimed in claim 1, wherein said message control center comprises an output unit for retrieving messages from said message database for displaying, modifying tags of the messages, and then storing the messages back to said message database.

7. The system as claimed in claim 1, wherein said message control center comprises a control unit for repeatedly checking message tags in accordance with said at least one parameter setting.

8. The system as claimed in claim 1, wherein said message control center comprises a receiving unit for receiving messages from a transmission layer, unpacking the messages in accordance with a communication protocol, attaching tags to the messages, and then storing the messages into said message database.

9. The system as claimed in claim 1, wherein said message control center comprises a delivering unit for retrieving messages from said message database, packeting the messages in accordance with a communication protocol, delivering the messages to a transmission layer, and modifying tags of the messages according to a return code from the transmission layer.

10. A message delivering system capable of automatically storing and retransmitting for an IP phone, the message delivering system comprising:
a message database for storing unsent messages;
a parameter-setting unit having at least one parameter setting; and
a message control center for retrieving the unsent messages from the message database for delivering in accordance with the at least one parameter setting, the message control center comprising:
an input unit for inputting messages, attaching tags to the messages, and storing the messages into said message database;
a control unit for repeatedly checking message tags in accordance with said at least one parameter setting; and
a delivering unit for retrieving messages from said message database, packeting the messages in accordance with a communication protocol, delivering the messages to a transmission layer, and modifying tags of the messages according to a return code from the transmission layer.

11. The message delivering system as claimed in claim 10, wherein said at least one parameter setting comprises a polling interval, said message control center checking said message database repeatedly in a frequency defined in accordance with the polling interval for any said unsent message.

12. The message delivering system as claimed in claim 10, wherein said at least one parameter setting comprises an expiration period, said message control center skipping all said unsent messages residing in said message database for a time longer than said expiration period.

13. The message delivering system as claimed in claim 10, wherein said at least one parameter setting comprises an automatic redial mode setting for enabling or disabling said message control center.

14. A message receiving system capable of automatically storing and retransmitting for an IP phone, the system comprising:
a message database for storing new messages;
a parameter-setting unit having at least one parameter setting; and
a message control center for retrieving the new messages from the message database for displaying in accordance with the at least one parameter setting, the message control center comprising:
an output unit for retrieving messages from said message database for displaying, modifying tags of the messages, and then storing the messages back to said message database;
a control unit for repeatedly checking message tags in accordance with said at least one parameter setting; and
a receiving unit for receiving messages from a transmission layer, unpacking the messages in accordance with a communication protocol, attaching tags to the messages, and then storing the messages into said message database.

15. The message receiving system as claimed in claim 14, wherein said at least one parameter setting comprises a polling interval, said message control center checking said message database repeatedly in a frequency defined in accordance with the polling interval for any said new message.

16. The message receiving system as claimed in claim 14, wherein said at least one parameter setting comprises an automatic redial mode setting for enabling or disabling said message control center.

17. A message delivering method capable of automatically storing and retransmitting for an IP phone, the message delivering method comprising:
providing a message;
attaching an unsent tag and a message built time to the message, and then storing the message into a message database;
repeatedly checking message tags in the message database in accordance with at least one parameter setting;
delivering the message with the unsent tag if the message is not expired according to the message built time and an expiration period defined by the at least one parameter setting; skipping the processing of the message otherwise;
returning a success code if the message has been delivered successfully.

18. A message receiving method capable of automatically storing and retransmitting for an IP phone, the message receiving method comprising:
receiving a message from a transmission layer;
attaching a new tag to the message and storing the message into a message database; and
retrieving the message with the new tag from the message database, displaying the message, modifying the new tag to a displayed tag, and then storing the message back to the message database.
